(19) United States
(12) Patent Application Publication
(10) Pub. No.: US 2022/0212903 A1
(43) Pub. Date: Jul. 7, 2022

(54) UPGRADED QUAY CRANE SYSTEM AND OPERATION PROCESS

(71) Applicant: HUADIAN LANCO TECHNOLOGIES CO., LTD., Beijing (CN)

(72) Inventors: SHUWANG GUO, Beijing (CN); QIANG XIAO, Beijing (CN); YINGJIU ZHAO, Beijing (CN); XUEFENG ZHENG, Beijing (CN)

(21) Appl. No.: 17/594,911

(22) PCT Filed: Jul. 12, 2019
(86) PCT No.: PCT/CN2019/095671

§ 371 Date: Nov. 3, 2021

(30) Foreign Application Priority Data
May 4, 2019 (CN) 201910366750.3

(51) Int. Cl. B66C 19/00; B66C 7/02; B66C 9/14; B66C 11/04

(52) U.S. Cl. CPC B66C 19/002; B66C 11/04; B66C 9/14; B66C 7/02

(57) ABSTRACT

An upgraded quay crane system and an operation process, wherein a conventional quay crane girder is upgraded into a double-trapezoid four-track girder (1). An upper trolley (2) travels on upper trolley running tracks (a16) on an inner side of the double-trapezoid four-track girder (1), a lower trolley (3) is suspended upside down on lower trolley running tracks (a8) on an outer side of the double-trapezoid four-track girder (1), and a container (5) hoisted by the upper trolley (2) via a hoist (4) is able to pass through the lower trolley (3). The present quay crane system improves on the conventional quay crane having a single operation trolley by adding one more operation trolley on the outer side of the original quay crane girder. The two trolleys are vertically disposed, and the space structure for the lower trolley is cleverly designed, such that the two trolleys can operate independently without interfering with each other. The two trolleys of the upgraded quay crane have enough space to pass by each other and operate at the same time, thereby doubling loading and unloading efficiency.

### CROSS-REFERENCE TO RELATED APPLICATIONS

This application is a 371 of International Patent Application Number PCT/CN2019/095671, filed on Jul. 12, 2019, which claims the benefit and priority of Chinese Patent Application Number 201910366750.3, filed on May 4, 2019 with China National Intellectual Property Administration, the disclosures of which are incorporated herein by reference in their entireties.

### TECHNICAL FIELD

The present disclosure relates to the technical field of port equipment, in particular to, an upgraded quay crane system and an operation process.

### BACKGROUND

The rapid development of the world economy is stimulating shipping logistics to rapidly develop, and thus, the global container throughput is increasing. In order to reduce the transportation cost, a container ship is increasingly developed toward large size, and a 3E-level container ship having the container capacity 22000TEU has been put into use, which requires higher loading and unloading efficiency of a port. As key loading and unloading equipment on a container wharf, a container quay crane directly operates a ship and plays an important role for the overall loading and unloading efficiency of the wharf. At present, a conventional quay crane having a single trolley has been mostly applied at home and abroad, and containers are loaded and unloaded by adopting the single trolley, in such a way, the loading and unloading efficiency of the single quay crane reaches the limit, but the demand of a wharf for the loading and unloading efficiency still cannot be met. For a large container ship, a manner of increasing the number of operations of the quay crane is almost adopted to increase the every-hour loading and unloading efficiency of the ship, but demands of clients for the every-hour loading and unloading efficiency of the ship cannot be met by simply increasing the number of the operations of the quay crane due to an operation interval of the quay crane. If the conventional quay crane having the single trolley is directly abandoned and replaced with a more advanced quay crane system that is newly established, people will face huge investment cost and great waste of available resources. Therefore, in order to reduce the investment cost and increase the loading and unloading efficiency of the conventional quay crane, people have to break through conventional thinking to upgrade the conventional quay crane.

### SUMMARY

The objective of the present disclosure is to provide an upgraded quay crane system which improves on a conventional quay crane having a single operation trolley by adding one more operation trolley on an outer side of an original quay crane girder. The two trolleys are vertically disposed, and the space structure for the lower trolley is cleverly designed, such that the two trolleys can operate independently without interfering with each other. Meanwhile, the section form of the present quay crane girder is upgraded to meet a demand for laying lower-trolley running tracks. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency. Further provided is an operation process of an upgraded quay crane system, by which a present quay crane on a container wharf is upgraded to solve the bottleneck encountered when the loading and unloading efficiency of the present quay crane is increased, so that the overall loading and unloading efficiency of the wharf is increased, and the berth throughput capacity of the wharf is improved.

In order to solve the above-mentioned technical problem, the present disclosure adopts the following technical solutions:

provided is an upgraded quay crane system, wherein a conventional quay crane girder is upgraded into a double-trapezoid four-track girder. Upper-trolley running tracks on inner sides of the double-trapezoid four-track girder are configured for an upper trolley to travel on, a lower trolley is suspended upside down on lower-trolley running tracks on outer sides of the double-trapezoid four-track girder, and a container hoisted by the upper trolley via a hoist is able to pass through the lower trolley. The double-trapezoid four-track girder includes original box beams, plates-A, plates-B, and track bearing beams; tops of the two original box beams are connected by a connecting frame of a quay crane, structures of the two original box beams are symmetrically disposed relative to the center of the connecting frame, sections of bottom parts of the two original box beams are of right-angled trapezoids, each of the right-angled trapezoids includes a right-angled side, an oblique side, an upper base, and a lower base, the oblique sides of the bottom parts of the two original box beams are both located on inner sides of the quay crane, the right-angled sides thereof are both located on outer sides of the quay crane, and the two oblique sides are provided with the upper-trolley running tracks which are symmetrically arranged; each of the plates-B is laid along the longitudinal direction of a corresponding original box beam, each of the plates-B is located on an outer side of a corresponding lower base, one side of each of the plates-B is connected with one side of the corresponding lower base, and each of the plates-B is located on the same horizontal height as the corresponding lower base; each of the plates-A is laid along the longitudinal direction of a corresponding original box beam, one side of each of each of the plates-A is connected with the other side, away from a corresponding lower base, of a corresponding plate-B, and the other side of each of the plates-A is connected with an outer side of the corresponding original box beam; and each of the track bearing beams is mounted on one end, away from a corresponding lower base, of a corresponding plate-B, and each of the lower-trolley running tracks is laid on a corresponding track bearing beam. According to the present disclosure, the conventional quay crane girder is upgraded in a manner that outer sides of the two original box beams are each additionally provided with two plates to form a girder with a double-trapezoid section, and the outer side of the girder with the double-trapezoid section is additionally provided with track bearing beams and is laid with the lower-trolley running tracks to bear the newly added lower trolley which is suspended upside down. The track pitch between the original upper-trolley running tracks of the original box beams is kept unchanged, and the two upper-trolley running tracks which are symmetrically arranged are configured for the upper trolley to travel on. The lower trolley is additionally arranged on the outer-side tracks of the original box beams. The two trolleys are vertically disposed, and the space structure for the lower trolley is cleverly designed, such that the upper trolley and the lower trolley of the upgraded quay crane have enough space to pass by each other without interfering with each other; and the quay crane is upgraded from one trolley to two trolleys to operate, so that the operation efficiency of the quay crane is greatly increased. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency.

For the aforementioned upgraded quay crane system, the upper trolley includes an upper trolley body, the hoist includes an upper hoist frame, and the upper trolley body is connected to the upper hoist frame via steel ropes; a guide device including a guide frame and a guide rod is further arranged between the upper trolley body and the upper hoist frame, the guide frame is arranged on the top of the upper hoist frame, the guide rod is arranged on the bottom of the upper trolley body, and the guide frame is configured to slidably engage the guide rod; and the guide frame includes a guide groove and a supporting structure, and the guide groove is arranged on the top of the supporting structure. When the container hoisted by the upper trolley is lifted to the highest position to pass through the lower trolley, the guide rod is smoothly inserted into the guide groove to limit the swing of the hoist and the container, so that the container hoisted by the upper trolley can pass through the lower trolley without interference. The two trolleys of the upgraded quay crane have enough space to pass by each other safely and stably and operate at the same time, thereby doubling the loading and unloading efficiency.

The aforementioned upgraded quay crane system further includes a lower-trolley travelling mechanism, a lower-trolley hoisting mechanism, an upper-trolley travelling mechanism, an upper-trolley hoisting mechanism, an upper-trolley hoisting winding system, a lower-trolley hoisting winding system, an upper-trolley travelling winding system, and a lower-trolley travelling winding system, wherein the upper-trolley travelling mechanism is configured to drive the upper trolley to travel along the upper-trolley running tracks via the upper-trolley travelling winding system, and the upper-trolley hoisting mechanism is configured to drive the upper trolley to rise and fall via the upper-trolley hoisting winding system; the lower-trolley travelling mechanism is configured to drive the lower trolley to travel along the lower-trolley running tracks via the lower-trolley travelling winding system; the lower-trolley hoisting mechanism is configured to drive the hoist of the lower trolley to rise and fall via the lower-trolley hoisting winding system; wherein the lower-trolley travelling mechanism, the lower-trolley hoisting mechanism, the upper-trolley travelling mechanism and the upper-trolley hoisting mechanism are all arranged in a same machine room of the quay crane, and the upper-trolley hoisting winding system, the lower-trolley hoisting winding system, the upper-trolley travelling winding system and the lower-trolley travelling winding system are effectively staggered on the quay crane without interfering with each other. According to the present disclosure, due to the reasonable layout of mounting positions of the upper-trolley hoisting winding system, the lower-trolley hoisting winding system, the upper-trolley travelling winding system, and the lower-trolley travelling winding system, an interference phenomenon can be avoided when the upper-trolley hoisting winding system, the lower-trolley hoisting winding system, the upper-trolley travelling winding system and the lower-trolley travelling winding system operate on the quay crane, so that it is ensured that the upper trolley and the lower trolley pass by each other to stably operate.

For the aforementioned upgraded quay crane system, the upper-trolley hoisting mechanism is arranged in front of the upper-trolley travelling mechanism; the lower-trolley travelling mechanism includes a lower-trolley travelling mechanism part-A and a lower-trolley travelling mechanism part-B which are respectively arranged on left and right sides of the upper-trolley travelling mechanism; the lower-trolley hoisting mechanism includes a lower-trolley hoisting mechanism part-A, a lower-trolley hoisting mechanism part-B, and a floating coupling, the lower-trolley hoisting mechanism part-A is connected to the lower-trolley hoisting mechanism part-B via the floating coupling, wherein the floating coupling is horizontally arranged in a gap between the upper-trolley travelling mechanism and the upper-trolley hoisting mechanism, and the lower-trolley hoisting mechanism part-A and the lower-trolley hoisting mechanism part-B are respectively arranged on left and right sides of the upper-trolley hoisting mechanism. Since the machine room is limited in space, the lower-trolley travelling mechanism and the lower-trolley hoisting mechanism which are newly added may also be mounted on the premise that the upper-trolley travelling mechanism and the upper-trolley hoisting mechanism are mounted, it is unnecessary to newly build a machine room and reduce the upgrading cost, and the remaining space of the original machine room is sufficiently utilized. The present disclosure designs the novel lower-trolley hoisting mechanism which specifically includes the lower-trolley hoisting mechanism part-A, the lower-trolley hoisting mechanism part-B and the floating coupling, wherein due to the arrangement of the floating coupling, it can be ensured that the lower-trolley hoisting mechanism part-A and the lower-trolley hoisting mechanism part-B operate synchronously, and the problem that the hoist of the lower trolley tilts due to operation asynchronism of the two mechanisms is avoided, which is a great innovation for the lower-trolley hoisting mechanism. In addition, the machine room is limited in space, in order to place the newly added lower-trolley hoisting mechanism part-A and lower-trolley hoisting mechanism part-B without newly building a machine room or reducing the upgrading cost, the floating coupling plays a good linking role, and the floating coupling is set to be small-sized and is respectively connected with the lower-trolley hoisting mechanism part-A and the lower-trolley hoisting mechanism part-B on the left and the right, so that the remaining space of the original machine room is sufficiently utilized, the utility rate of the space is increased, and the stable operation of the newly added lower trolley can also be guaranteed. Specifically, the lower-trolley travelling mechanism part-A includes a travelling drum-A, a motor, and a speed reducer, wherein one side of the speed reducer is connected with the motor by a shaft, and the other side of the speed reducer is connected with the travelling drum-A by a shaft. The lower-trolley travelling mechanism part-B includes a travelling drum-B, a motor, and a speed reducer, wherein one side of the speed reducer is connected with the motor by a shaft, and the other side of the speed reducer is connected with the travelling drum-B by a shaft.

For the aforementioned upgraded quay crane system, the lower trolley includes a recessed frame, a movable trolley and wheels, wherein the wheels are arranged on two sides of the top of the recessed frame and are configured to roll on the lower-trolley running tracks on the outer sides of the double-trapezoid four-track girder, the movable trolley is arranged on the bottom of the recessed frame, and the hoist is connected below the movable trolley. The lower trolley is provided with the recessed frame which forms a recessed self-closed space in space, and such a space is large enough to allow the container hoisted by the upper trolley to pass by without interference. Compared with a U-shaped frame of a lower trolley of a novel quay crane, the present structure allows the upper trolley to pass through the recessed space of the lower trolley without changing the position of the double-trapezoid four-track girder, thereby reducing the investment. The movable trolley is used for bearing the hoist and is capable of moving on the recessed frame.

For the aforementioned upgraded quay crane system, a movable trolley track is laid on the bottom of the recessed frame, the movable trolley includes a trolley body and travelling wheels, and the travelling wheels are mounted on two sides of the bottom of the trolley body and are configured to roll on the movable trolley track.

For the aforementioned upgraded quay crane system, the recessed frame includes a horizontal frame, a first vertical frame group, and a second vertical frame group, wherein one end of the horizontal frame is connected with an end of the first vertical frame group, the other end of the horizontal frame is connected with an end of the second vertical frame group, and structures of the first vertical frame group and the second vertical frame group are symmetrically disposed relative to the middle of the horizontal frame. The first vertical frame group includes a first vertical rod and a second vertical rod; the second vertical frame group further includes a first vertical rod and a second vertical rod; and the wheels are arranged on top ends of the first vertical rods, the other ends of the first vertical rods are connected with ends of the second vertical rods, and the other ends, away from the first vertical rods, of the second vertical rods are connected with the horizontal frame. In such a layout way, the upper trolley and the lower trolley can pass by each other without changing a girder spacing of the conventional quay crane on the premise that the upgrading cost is relatively low, and interference can also be avoided.

For the aforementioned upgraded quay crane system, horizontal guide wheel groups are further mounted on the top of the recessed frame and are arranged on outer sides of the wheels; each of the horizontal guide wheel groups includes a horizontal wheel and a rotation shaft, and the horizontal wheel is coaxially sleeved on the rotation shaft and is able to rotate around the rotation shaft; and the horizontal wheel has a shape of an inverted horn. The horizontal guide wheel group can prevent the wheels of the lower trolley from deviating and also reduce the abrasion of the lower-trolley running tracks. Specifically, when the lower trolley laterally deviates, the horizontal guide wheel group may abut against the outer sides of the wheels to correct the lateral deviation of the wheels by virtue of an opposite force. In addition, when the lower trolley deviates from the lower-trolley running tracks, the horizontal wheel rotates on sides of the lower-trolley running tracks around the rotation shaft, so that friction can be reduced, and the abrasion of the lower-trolley running tracks can be reduced.

For the aforementioned upgraded quay crane system, trolley moving devices are further mounted on two sides of the movable trolley, each of the trolley moving devices includes a motor, a speed reducer, an electrically-driven push rod, and a supporting seat, wherein the motor is connected with the speed reducer by a shaft, the speed reducer is connected with the electrically-driven push rod by a shaft, one end, away from the speed reducer, of the electrically-driven push rod is connected with the trolley body of the movable trolley, and the bottom of the electrically-driven push rod is fixedly arranged on the horizontal frame via the supporting seat. The trolley moving devices have various functions including a first function of controlling the movable trolley to accurately move and a second function of fixing the movable trolley. Specifically, the motor supplies power for realizing the extension and contraction of the electrically-driven push rod, the electrically-driven push rod is connected with the trolley body to control the moving position of the movable trolley, in addition, the speed reducer may be used for speed adjustment. The trolley moving devices control the movable trolley to move the hoist, thereby completing box operation; and the fine adjustment process is rapid, simple and convenient, and the loading and unloading efficiency is increased. The trolley moving devices limit the displacement of the movable trolley on the movable trolley track, and the movable trolley is fixed when the electrically-driven push rod is locked, so that potential safety hazards caused by waggle of the movable trolley under the action of an external force such as crosswind are avoided.

For the aforementioned upgraded quay crane system, the lower-trolley hoisting mechanism part-A includes a hoist drum-A, a motor, and a speed reducer, wherein one side of the motor is coaxially connected with the speed reducer, and the other side of the motor is connected with the hoist drum-A by a shaft; and the lower-trolley hoisting mechanism part-B includes a hoist drum-B, a motor, and a speed reducer, wherein one side of the motor is coaxially connected with the speed reducer, and the other side of the motor is connected with the hoist drum-B by a shaft.

For the aforementioned upgraded quay crane system, the lower-trolley hoisting winding system includes a lower-trolley hoisting winding group-A and a lower-trolley hoisting winding group-B, the lower-trolley hoisting mechanism part-A is configured to drive the hoist of the lower trolley to rise and fall via the lower-trolley hoisting winding group-A, and meanwhile, the lower-trolley hoisting mechanism part-B is configured to drive the hoist of the lower trolley to rise and fall via the lower-trolley hoisting winding group-B.

For the aforementioned upgraded quay crane system, the recessed frame includes a horizontal frame, a first vertical frame group, and a second vertical frame group, wherein one end of the horizontal frame is connected with an end of the first vertical frame group, the other end of the horizontal frame is connected with an end of the second vertical frame group, and structures of the first vertical frame group and the second vertical frame group are symmetrically disposed relative to the middle of the horizontal frame; wherein a first horizontal support frame-A is further connected to the top of the first vertical frame group, and a first horizontal support frame-B is further connected to the top of the second vertical frame group. The lower-trolley hoisting winding group-A includes a first quay crane redirecting pulley and a second quay crane redirecting pulley which are mounted on the quay crane, further includes a thirteenth pulley, a fourteenth pulley, a fifteenth pulley, a twenty-second pulley, a twenty-third pulley, and a twenty-fourth pulley which are mounted on the first horizontal support frame-A, further includes a sixteenth pulley and a twenty-first pulley which are mounted on the first vertical frame group, further includes a seventeenth pulley, an eighteenth pulley, a nineteenth pulley, and a twentieth pulley which are mounted on the horizontal frame, further includes a hoist pulley-A mounted on the hoist of the lower trolley, and further includes a quay crane pulley-A mounted on the double-trapezoid four-track girder of the quay crane. The lower-trolley hoisting winding group-B includes a hoist rope-A, further includes a third quay crane redirecting pulley and a fourth quay crane redirecting pulley which are mounted on the quay crane, further includes a first pulley, a second pulley, a third pulley, a tenth pulley, an eleventh pulley, and a twelfth pulley which are mounted on the first horizontal support frame-B, further includes a fourth pulley and a ninth pulley which are mounted on the second vertical frame group, further includes a fifth pulley, a sixth pulley, a seventh pulley, and an eighth pulley which are mounted on the horizontal frame, further includes a hoist pulley-B mounted on the hoist of the lower trolley, and further includes a quay crane pulley-B mounted on the double-trapezoid four-track girder of the quay crane. Specifically, one end of the hoist rope-A is wound on the hoist drum-B, and the other end of the hoist rope-A, after being sequentially wound through an upper side of the third quay crane redirecting pulley, wound through a lower side of the fourth quay crane redirecting pulley, wound through a lower side of the first pulley, redirected by 180 degrees, wound through the second pulley, redirected by 180 degrees, wound through the third pulley, downwards wound through the fourth pulley, further downwards wound through the fifth pulley, horizontally redirected, wound through the sixth pulley, vertically redirected, wound through the hoist pulley-B, vertically and upwards redirected by 180 degrees, wound through the seventh pulley, wound through a lower side of the eighth pulley, vertically and upwards wound through the ninth pulley, upwards wound through the tenth pulley, wound through the eleventh pulley, horizontally redirected by 180 degrees, further wound through the twelfth pulley, horizontally redirected by 180 degrees, wound through the quay crane pulley-B, wound through the quay crane pulley-A, wound through the thirteenth pulley, redirected by 180 degrees, wound through the fourteenth pulley, redirected by 180 degrees, wound through the fifteenth pulley, downwards wound through the sixteenth pulley, further downwards wound through the seventeenth pulley, horizontally redirected, wound through the eighteenth pulley, vertically redirected, wound through the hoist pulley-A, redirected by 180 degrees, wound through the nineteenth pulley, wound through the twentieth pulley, wound through the twenty-first pulley, wound through the twenty-second pulley, wound through the twenty-third pulley, redirected by 180 degrees, wound through the twenty-fourth pulley, redirected by 180 degrees, wound through the second quay crane redirecting pulley, and wound through the first quay crane redirecting pulley, is finally wound on the hoist drum-A.

For the aforementioned upgraded quay crane system, several rope dragging frames are further arranged on outer side surfaces of the double-trapezoid four-track girder in the longitudinal direction of the girder, and the hoist rope-A is arranged on the rope dragging frames.

For the aforementioned upgraded quay crane system, the upper trolley body is connected with both sides of the upper hoist frame by the steel ropes, and the guide device is arranged on inner sides of the steel ropes. In such a layout way that flexible connecting pieces are arranged on outer sides and rigid connecting pieces are arranged on inner sides, when the upper trolley is uncrossed with the lower trolley, an operation process is smoother and is free of excessive interference.

Provided is an operation process of the aforementioned upgraded quay crane system, wherein the operation process includes the following steps: upgrading a conventional quay crane girder into a double-trapezoid four-track girder, arranging an upper trolley to travel on upper-trolley running tracks on inner sides of the double-trapezoid four-track girder, suspending a lower trolley upside down on lower-trolley running tracks on outer sides of the double-trapezoid four-track girder, wherein a container hoisted by the upper trolley via a hoist is able to pass through the lower trolley. Wherein an upper-trolley travelling mechanism drives the upper trolley to travel along the upper-trolley running tracks via an upper-trolley travelling winding system, and an upper-trolley hoisting mechanism drives the upper trolley to rise and fall via an upper-trolley hoisting winding system; a lower-trolley travelling mechanism drives the lower trolley to travel along the lower-trolley running tracks via a lower-trolley travelling winding system; a lower-trolley hoisting mechanism drives the hoist of the lower trolley to rise and fall via a lower-trolley hoisting winding system; wherein the lower-trolley travelling mechanism, the lower-trolley hoisting mechanism, the upper-trolley travelling mechanism and the upper-trolley hoisting mechanism are all arranged in a same machine room of a quay crane, and the upper-trolley hoisting winding system, the lower-trolley hoisting winding system, the upper-trolley travelling winding system and the lower-trolley travelling winding system are effectively staggered on a quay crane without interfering with each other.

Compared with the prior art, the present disclosure has the following benefits.

1. According to the present disclosure, the conventional quay crane girder is upgraded in a manner that outer sides of the two original box beams are each additionally provided with two plates to form a girder with a double-trapezoid section, and the outer side of the girder with the double-trapezoid section is additionally provided with track bearing beams and is laid with the lower-trolley running tracks to bear the newly added lower trolley which is suspended upside down. The track pitch between the original upper-trolley running tracks of the original box beams is kept unchanged, and the two upper-trolley running tracks which are symmetrically arranged are configured for the upper trolley to travel on. The lower trolley is additionally arranged on the outer-side tracks of the original box beams. The two trolleys are vertically disposed, and the space structure for the lower trolley is cleverly designed, such that the upper trolley and the lower trolley of the upgraded quay crane have enough space to pass by each other without interfering with each other; and the quay crane is upgraded from one trolley to two trolleys to operate, so that the operation efficiency of the quay crane is greatly increased. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency.

2. The effect of the guide device lies in that when the container hoisted by the upper trolley is lifted to the highest position to pass through the lower trolley, the guide rod is smoothly inserted into the guide groove to limit the swing of the hoist and the container, so that the container hoisted by the upper trolley can pass through the lower trolley without interference. The two trolleys of the upgraded quay crane have enough space to pass by each other safely and stably and operate at the same time, thereby doubling the loading and unloading efficiency. In such a layout way, when the distance between the upper trolley and the upper hoist frame becomes small due to the extension and contraction of the steel ropes, the guide rod can smoothly enter the guide groove or enter the supporting structure via the guide groove, so that the two trolleys can stably pass by each other; and in such a layout way that flexible connecting pieces are arranged on outer sides and rigid connecting pieces are arranged on inner sides, when the upper trolley is uncrossed with the lower trolley, an operation process is smoother and is free of excessive interference.

3. According to the present disclosure, due to the reasonable layout of mounting positions of the upper-trolley hoisting winding system, the lower-trolley hoisting winding system, the upper-trolley travelling winding system, and the lower-trolley travelling winding system, an interference phenomenon can be avoided when the upper-trolley hoisting winding system, the lower-trolley hoisting winding system, the upper-trolley travelling winding system and the lower-trolley travelling winding system operate on the quay crane, so that it is ensured that the upper trolley and the lower trolley pass by each other to stably operate.

4. Since the machine room is limited in space, the lower-trolley travelling mechanism and the lower-trolley hoisting mechanism which are newly added may also be mounted on the premise that the upper-trolley travelling mechanism and the upper-trolley hoisting mechanism are mounted, it is unnecessary to newly build a machine room and reduce the upgrading cost, and the remaining space of the original machine room is sufficiently utilized. The present disclosure designs the novel lower-trolley hoisting mechanism which specifically includes the lower-trolley hoisting mechanism part-A, the lower-trolley hoisting mechanism part-B and the floating coupling, wherein due to the arrangement of the floating coupling, it can be ensured that the lower-trolley hoisting mechanism part-A and the lower-trolley hoisting mechanism part-B operate synchronously, and the problem that the hoist of the lower trolley tilts due to operation asynchronism of the two mechanisms is avoided, which is a great innovation for the lower-trolley hoisting mechanism. In addition, the machine room is limited in space, in order to place the newly added lower-trolley hoisting mechanism part-A and lower-trolley hoisting mechanism part-B without newly building a machine room or reducing the upgrading cost, the floating coupling plays a good linking role, and the floating coupling is set to be small-sized and is respectively connected with the lower trolley hoisting mechanism part-A and the lower-trolley hoisting mechanism part-B on the left and the right, so that the remaining space of the original machine room is sufficiently utilized, the utility rate of the space is increased, and the stable operation of the newly added lower trolley can also be guaranteed. Specifically, the lower-trolley travelling mechanism part-A includes a travelling drum-A, a motor, and a speed reducer, wherein one side of the speed reducer is connected with the motor by a shaft, and the other side of the speed reducer is connected with the travelling drum-A by a shaft. The lower-trolley travelling mechanism part-B includes a travelling drum-B, a motor, and a speed reducer, wherein one side of the speed reducer is connected with the motor by a shaft, and the other side of the speed reducer is connected with the travelling drum-B by a shaft.

5. The lower trolley is provided with the recessed frame which forms a recessed self-closed space in space, and such a space is large enough to allow the container hoisted by the upper trolley to pass by without interference. Compared with a U-shaped frame of a lower trolley of a novel quay crane, the present structure allows the upper trolley to pass through the recessed space of the lower trolley without changing the position of the double-trapezoid four-track girder, thereby reducing the investment. The movable trolley is used for bearing the hoist and is capable of moving on the recessed frame.

6. In such a layout way, the upper trolley and the lower trolley can pass by each other without changing a girder spacing of the conventional quay crane on the premise that the upgrading cost is relatively low, and interference can also be avoided.

7. The horizontal guide wheel group can prevent the wheels of the lower trolley from deviating and also reduce the abrasion of the lower-trolley running tracks. Specifically, when the lower trolley laterally deviates, the horizontal guide wheel group may abut against the outer sides of the wheels to correct the lateral deviation of the wheels by virtue of an opposite force. In addition, when the lower trolley deviates from the lower-trolley running tracks, the horizontal wheel rotates on sides of the lower-trolley running tracks around the rotation shaft, so that friction can be reduced, and the abrasion of the lower-trolley running tracks can be reduced.

8. The trolley moving devices have various functions including a first function of controlling the movable trolley to accurately move and a second function of fixing the movable trolley. Specifically, the motor supplies power for realizing the extension and contraction of the electrically-driven push rod, the electrically-driven push rod is connected with the trolley body to control the moving position of the movable trolley, in addition, the speed reducer may be used for speed adjustment. The trolley moving devices control the movable trolley to move the hoist, thereby completing box operation; and the fine adjustment process is rapid, simple and convenient, and the loading and unloading efficiency is increased. The trolley moving devices limit the displacement of the movable trolley on the movable trolley track, and the movable trolley is fixed when the electrically-driven push rod is locked, so that potential safety hazards caused by waggle of the movable trolley under the action of an external force such as crosswind are avoided.

### BRIEF DESCRIPTION OF THE DRAWINGS

FIG. 1 is a structural schematic diagram of a double-trapezoid four-track girder in accordance with the present disclosure;

FIG. 2 is a structural schematic diagram of application of an upper trolley and a lower trolley in accordance with the present disclosure;

FIG. 3 is a structural schematic diagram of cooperation of a guide rod and an upper trolley body in accordance with the present disclosure;

FIG. 4 is a structural schematic diagram of cooperation of a guide frame and an upper hoist frame in accordance with the present disclosure;

FIG. 5 is a layout schematic diagram of a machine room in accordance with the present disclosure;

FIG. 6 is a front view of cooperation of the upper trolley and the lower trolley in accordance with the present disclosure;

FIG. 7 is a side view of cooperation of the upper trolley and the lower trolley in accordance with the present disclosure;

FIG. 8 is a structural schematic diagram of a movable trolley in accordance with the present disclosure;

FIG. 9 is a structural schematic diagram of a horizontal guide wheel group in accordance with the present disclosure;

FIG. 10 is a structural schematic of a trolley moving device in accordance with the present disclosure;

FIG. 11 is a structural schematic diagram of a lower-trolley hoisting winding system in accordance with the present disclosure; and

FIG. 12 is a structural schematic diagram of a lower-trolley hoisting mechanism in accordance with the present disclosure.

Meanings of reference numerals in the accompanying drawings: 1—double-trapezoid four-track girder, 2—upper trolley, 3—lower trolley, 4—hoist, 5—container, 16—machine room; a4—original box beam, a5—plate-A, a6—plate-B, a7—track bearing beam, a8—lower-trolley running track, a11—connecting frame, a12—right-angled side, a13—oblique side, a14—upper base, a15—lower base, and a16—upper-trolley running track; b4—guide device, b5—upper hoist frame, b7—guide frame, b8—guide rod, b9—upper trolley body, b10—guide groove, and b11—supporting structure; c7—lower-trolley travelling mechanism, c8—lower-trolley hoisting mechanism, c9—upper-trolley travelling mechanism, c10—upper-trolley hoisting mechanism, upper-trolley hoisting winding system, f6—lower-trolley hoisting winding system, upper-trolley travelling winding system, lower-trolley travelling winding system, c25—lower-trolley hoisting mechanism part-A, c26—lower-trolley hoisting mechanism part-B, c27—floating coupling, c28—lower-trolley travelling mechanism part-A, and c29—lower-trolley travelling mechanism part-B; d4—horizontal frame, d5—recessed frame, d6—movable trolley, d7—horizontal guide wheel group, d8—first vertical frame group, d9—second vertical frame group, d10—trolley body, d13—wheel, d17—travelling wheel, d18—horizontal wheel, d19—first vertical rod, d20—second vertical rod, and d21—rotation shaft; e7—trolley moving device, e18—motor, e21—speed reducer, e22—electrically-driven push rod, and e23—supporting seat; and f6—lower-trolley hoisting winding system, f17—hoist rope-A, f18—hoist drum-B, f19—hoist pulley-A, f20—hoist pulley-B, f21—quay crane pulley-A, f22—quay crane pulley-B, f23—hoist drum-A, f24—rope dragging frame, f26—lower-trolley hoisting winding group-A, f27—lower-trolley hoisting winding group-B, f28—motor, f29—speed reducer, f30—first quay crane redirecting pulley, f31—second quay crane redirecting pulley, f32—third quay crane redirecting pulley, f33—fourth quay crane redirecting pulley, f34—first horizontal support frame-A, f35—first horizontal support frame-B, 101—first pulley, 102—second pulley, 103—third pulley, 104—fourth pulley, 105—fifth pulley, 106—sixth pulley, 107—seventh pulley, 108—eighth pulley, 109—ninth pulley, 110—tenth pulley, 111—eleventh pulley, 112—twelfth pulley, 113—thirteenth pulley, 114—fourteenth pulley, 115—fifteenth pulley, 116—sixteenth pulley, 117—seventeenth pulley, 118—eighteenth pulley, 119—nineteenth pulley, 120—twentieth pulley, 121—twenty-first pulley, 122—twenty-second pulley, 123—twenty-third pulley, and 124—twenty-fourth pulley.

The present disclosure will be further described below with reference to the accompanying drawings and specific implementations.

### DETAILED DESCRIPTION OF THE EMBODIMENTS

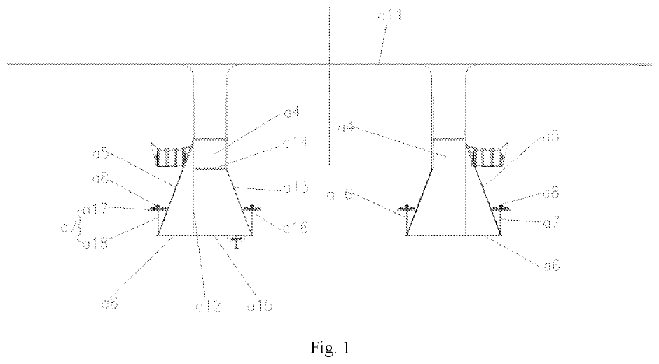

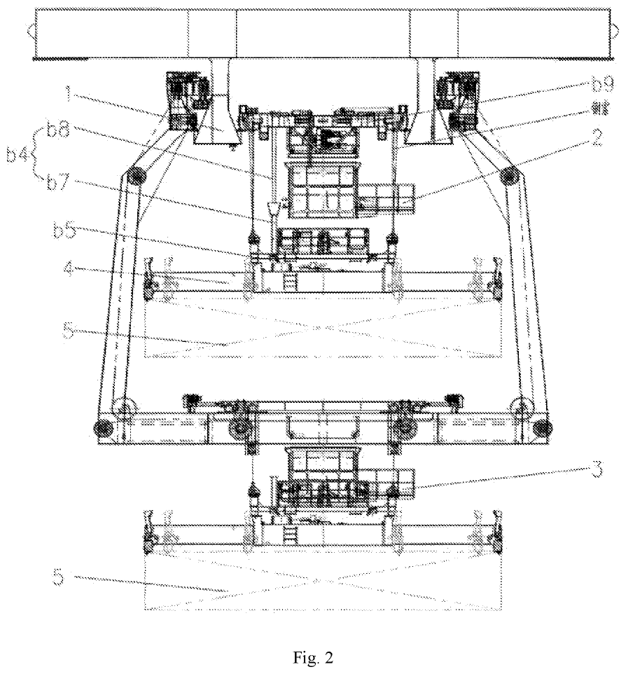

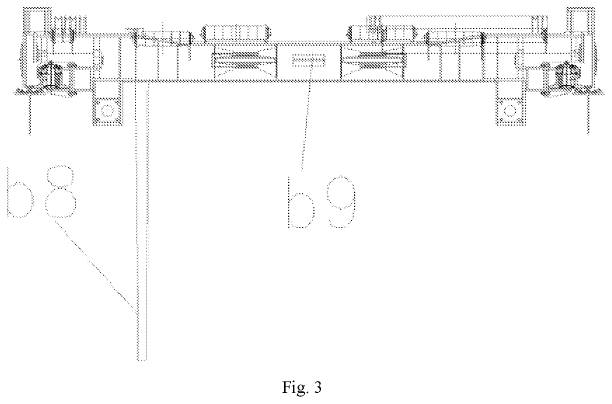

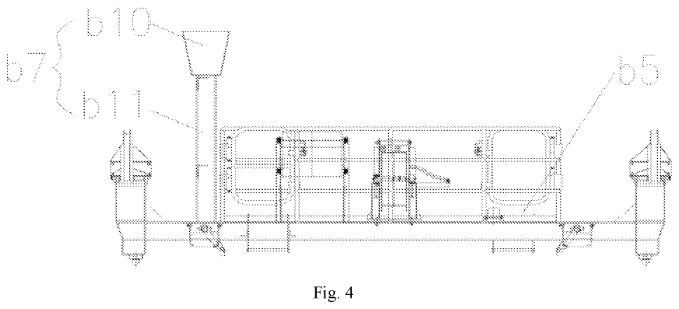

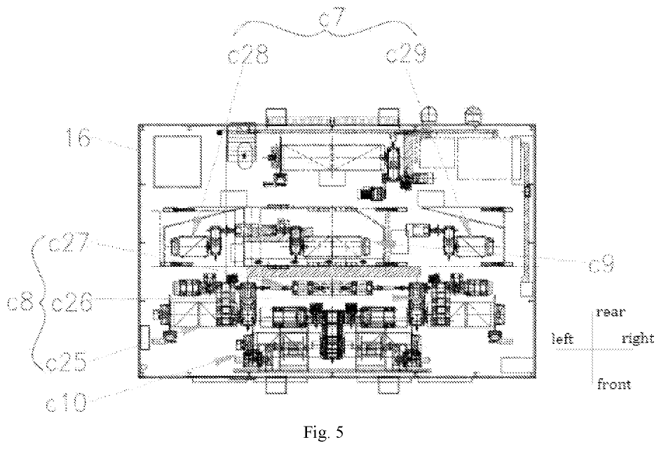

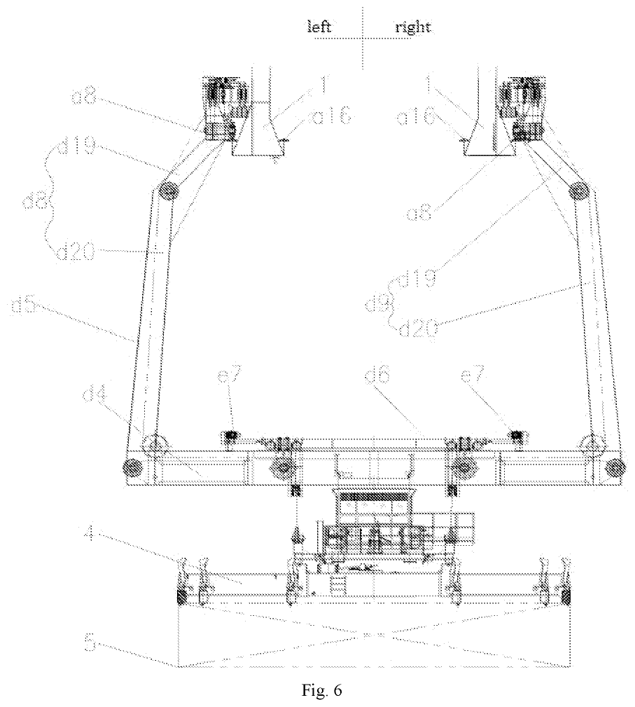

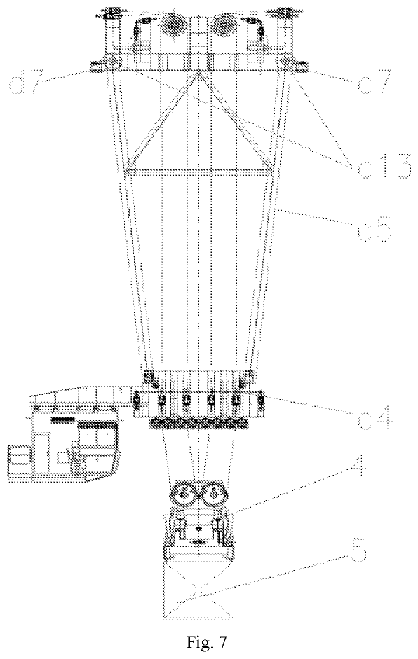

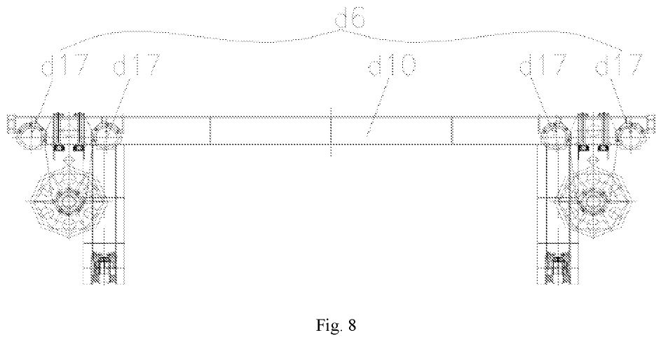

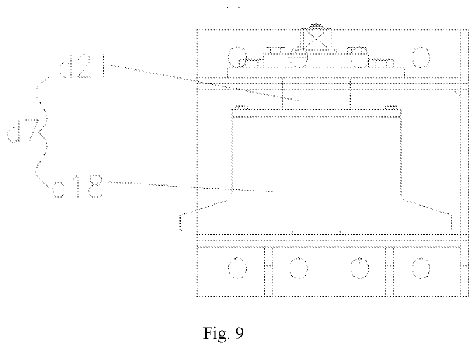

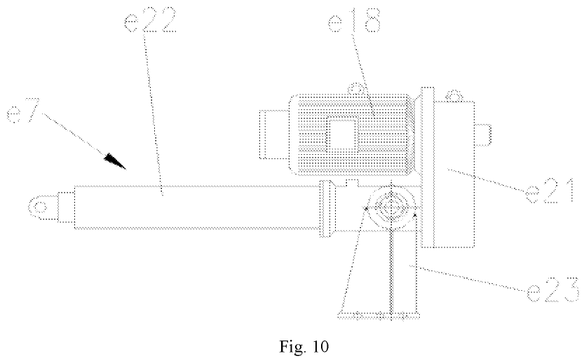

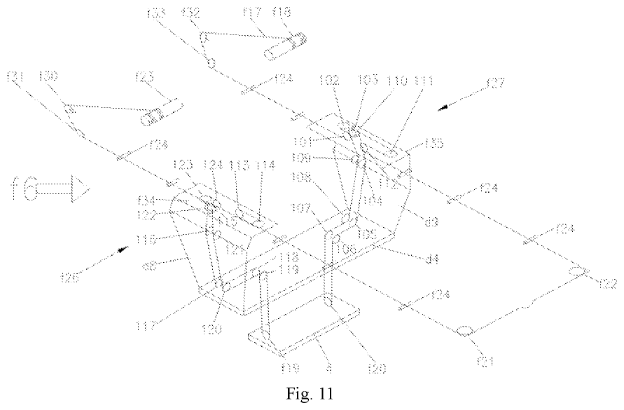

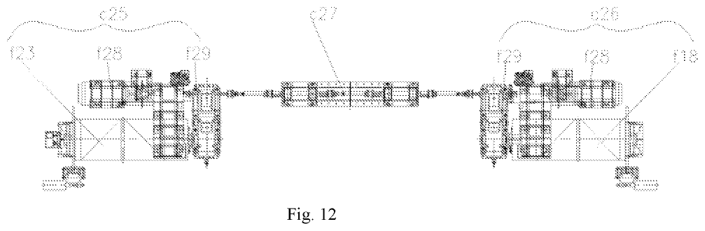

Embodiment 1 of the present disclosure: as shown in FIG. 1 to FIG. 12, provided is an upgraded quay crane system, wherein a conventional quay crane girder is upgraded into a double-trapezoid four-track girder 1. Upper-trolley running tracks a16 on inner sides of the double-trapezoid four-track girder 1 are configured for an upper trolley 2 to travel on, a lower trolley 3 is suspended upside down on lower-trolley running tracks a8 on outer sides of the double-trapezoid four-track girder 1, and a container 5 hoisted by the upper trolley 2 via a hoist 4 is able to pass through the lower trolley 3. The double-trapezoid four-track girder 1 includes original box beams a4, plates-A a5, plates-B a6, and track bearing beams a7; tops of the two original box beams a4 are interconnected by a connecting frame a11 of a quay crane, structures of the two original box beams a4 are symmetrically disposed relative to the center of the connecting frame a11, sections of bottom parts of the two original box beams a4 are of right-angled trapezoids, each of the right-angled trapezoids includes a right-angled side a12, an oblique side a13, an upper base a14, and a lower base a15, the oblique sides a13 of the bottom parts of the two original box beams a4 are both located on inner sides of the quay crane, the right-angled sides a12 thereof are both located on outer sides of the quay crane, and the two oblique sides a13 are provided with the upper-trolley running tracks a16 which are symmetrically arranged; each of the plates-B a6 is laid along the longitudinal direction of a corresponding original box beam a4, each of the plates-B a6 is located on an outer side of a corresponding lower base a15, one side of each of the plates-B a6 is connected with one side of the corresponding lower base a15, and each of the plates-B a6 is located on the same horizontal height as the corresponding lower base a15; each of the plates-A a5 is laid along the longitudinal direction of a corresponding original box beam a4, one side of each of the plates-A a5 is connected with the other side, away from a corresponding lower base a15, of a corresponding plate-B a6, and the other side of each of the plates-A a5 is connected with an outer side of the corresponding original box beam a4; and each of the track bearing beams a7 is mounted on one end, away from a corresponding lower base a15, of a corresponding plate-B a6, and each of the lower-trolley running tracks a8 is laid on a corresponding track bearing beam a7. According to the present disclosure, the conventional quay crane girder is upgraded in a manner that outer sides of the two original box beams a4 are each additionally provided with two plates to form a girder with a double-trapezoid section, and the outer side of the girder with the double-trapezoid section is additionally provided with track bearing beams a7 and is laid with the lower-trolley running tracks a8 to bear the newly added lower trolley 3 which is suspended upside down. The track pitch between the original upper-trolley running tracks a16 of the original box beams a4 is kept unchanged, and the two upper-trolley running tracks a16 which are symmetrically arranged are configured for the upper trolley to travel on. The lower trolley 3 is additionally arranged on the outer-side tracks of the original box beams a4. The two trolleys are vertically disposed, and the space structure for the lower trolley is cleverly designed, such that the upper trolley 2 and the lower trolley 3 of the upgraded quay crane have enough space to pass by each other without interfering with each other; and the quay crane is upgraded from one trolley to two trolleys to operate, so that the operation efficiency of the quay crane is greatly increased. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency.

Further, the upper trolley 2 includes an upper trolley body b9, the hoist 4 includes an upper hoist frame b5, and the upper trolley body b9 is connected to the upper hoist frame b5 via steel ropes; a guide device b4 including a guide frame b7 and a guide rod b8 is further arranged between the upper trolley body b9 and the upper hoist frame b5, the guide frame b7 is arranged on the top of the upper hoist frame b5, the guide rod b8 is arranged on the bottom of the upper trolley body b9, and the guide frame b7 is configured to slidably engage the guide rod b8; and the guide frame b7 includes a guide groove b10 and a supporting structure b11, and the guide groove b10 is arranged on the top of the supporting structure b11. When the container 5 hoisted by the upper trolley 2 is lifted to the highest position to pass through the lower trolley 3, the guide rod b8 is smoothly inserted into the guide groove b10 to limit the swing of the hoist 4 and the container 5, so that the container 5 hoisted by the upper trolley 2 can pass through the lower trolley 3 without interference. The two trolleys of the upgraded quay crane have enough space to pass by each other safely and stably and operate at the same time, thereby doubling the loading and unloading efficiency.

Further, the upper trolley body b9 is connected with both sides of the upper hoist frame b5 by the steel ropes, and the guide device b4 is arranged on inner sides of the steel ropes. In such a layout way that flexible connecting pieces are arranged on outer sides and rigid connecting pieces are arranged on inner sides, when the upper trolley 2 is uncrossed with the lower trolley 3, an operation process is smoother and is free of excessive interference.

Embodiment 2: as shown in FIG. 1 to FIG. 12, provided is an upgraded quay crane system, wherein a conventional quay crane girder is upgraded into a double-trapezoid four-track girder 1. Upper-trolley running tracks a16 on inner sides of the double-trapezoid four-track girder 1 are configured for an upper trolley 2 to travel on, a lower trolley 3 is suspended upside down on lower-trolley running tracks a8 on outer sides of the double-trapezoid four-track girder 1, and a container 5 hoisted by the upper trolley 2 via a hoist 4 is able to pass through the lower trolley 3. The double-trapezoid four-track girder 1 includes original box beams a4, plates-A a5, plates-B a6, and track bearing beams a7; tops of the two original box beams a4 are interconnected by a connecting frame a11 of a quay crane, structures of the two original box beams a4 are symmetrically disposed relative to the center of the connecting frame a11, sections of bottom parts of the two original box beams a4 are of right-angled trapezoids, each of the right-angled trapezoids includes a right-angled side a12, an oblique side a13, an upper base a14, and a lower base a15, the oblique sides a13 of the bottom parts of the two original box beams a4 are both located on inner sides of the quay crane, the right-angled sides a12 thereof are both located on outer sides of the quay crane, and the two oblique sides a13 are provided with the upper-trolley running tracks a16 which are symmetrically arranged; each of the plates-B a6 is laid along the longitudinal direction of a corresponding original box beam a4, each of the plates-B a6 is located on an outer side of a corresponding lower base a15, one side of each of the plates-B a6 is connected with one side of the corresponding lower base a15, and each of the plates-B a6 is located on the same horizontal height as the corresponding lower base a15; each of the plates-A a5 is laid along the longitudinal direction of a corresponding original box beam a4, one side of each of the plates-A a5 is connected with the other side, away from a corresponding lower base a15, of a corresponding plate B a6, and the other side of each of the plates-A a5 is connected with an outer side of the corresponding original box beam a4; and each of the track bearing beams a7 is mounted on one end, away from a corresponding lower base a15, of a corresponding plate-B a6, and each of the lower-trolley running tracks a8 is laid on a corresponding track bearing beam a7. According to the present disclosure, the conventional quay crane girder is upgraded, outer sides of the two original box beams a4 are each provided with two plates to form a girder with a double-trapezoid section, and the outer side of the girder with the double-trapezoid section is additionally provided with track bearing beams a7 and is laid with the lower-trolley running tracks a8 to bear the newly added lower trolley 3 which is suspended upside down. The track pitch between the original upper-trolley running tracks a16 of the original box beams a4 is kept unchanged, and the two upper-trolley running tracks a16 which are symmetrically arranged are configured for the upper trolley to travel on. The lower trolley 3 is additionally arranged on the outer-side tracks of the original box beams a4. The two trolleys are vertically disposed, and the space structure for the lower trolley is cleverly designed, such that the upper trolley 2 and the lower trolley 3 of the upgraded quay crane have enough space to pass by each other without interfering with each other; and the quay crane is upgraded from one trolley to two trolleys to operate, so that the operation efficiency of the quay crane is greatly increased. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency.

Further, the upgraded quay crane system further includes a lower-trolley travelling mechanism c7, a lower-trolley hoisting mechanism c8, an upper-trolley travelling mechanism c9, an upper-trolley hoisting mechanism c10, an upper-trolley hoisting winding system, a lower-trolley hoisting winding system f6, an upper-trolley travelling winding system, and a lower-trolley travelling winding system, wherein the upper-trolley travelling mechanism c9 is configured to drive the upper trolley 2 to travel along the upper-trolley running tracks a16 via the upper-trolley travelling winding system, and the upper-trolley hoisting mechanism c10 is configured to drive the upper trolley 2 to rise and fall via the upper-trolley hoisting winding system; the lower-trolley travelling mechanism c7 is configured to drive the lower trolley 3 to travel along the lower-trolley running tracks a8 via the lower-trolley travelling winding system; the lower-trolley hoisting mechanism c7 is configured to drive the hoist 4 of the lower trolley 3 to rise and fall via the lower-trolley hoisting winding system f6; wherein the lower-trolley travelling mechanism c7, the lower-trolley hoisting mechanism c8, the upper-trolley travelling mechanism c9 and the upper-trolley hoisting mechanism c10 are all arranged in a same machine room 16 of the quay crane, and the upper-trolley hoisting winding system, the lower-trolley hoisting winding system f6, the upper-trolley travelling winding system and the lower-trolley travelling winding system are effectively staggered on the quay crane without interfering with each other. According to the present disclosure, due to the reasonable layout of mounting positions of the upper-trolley hoisting winding system, the lower-trolley hoisting winding system f6, the upper-trolley travelling winding system, and the lower-trolley travelling winding system, an interference phenomenon can be avoided when the upper-trolley hoisting winding system, the lower-trolley hoisting winding system f6, the upper-trolley travelling winding system and the lower-trolley travelling winding system operate on the quay crane, so that it is ensured that the upper trolley 2 and the lower trolley 3 pass by each other to stably operate.

Further, the upper-trolley hoisting mechanism c10 is arranged in front of the upper-trolley travelling mechanism c9; the lower-trolley travelling mechanism c7 includes a lower-trolley travelling mechanism part-A c28 and a lower-trolley travelling mechanism part-B c29 which are respectively arranged on left and right sides of the upper-trolley travelling mechanism c9; the lower-trolley hoisting mechanism c8 includes a lower-trolley hoisting mechanism part-A c25, a lower-trolley hoisting mechanism part-B c26, and a floating coupling c27, the lower-trolley hoisting mechanism part-A c25 is connected to the lower-trolley hoisting mechanism part-B c26 via the floating coupling c27, wherein the floating coupling c27 is horizontally arranged in a gap between the upper-trolley travelling mechanism c9 and the upper-trolley hoisting mechanism c10, and the lower-trolley hoisting mechanism part-A c25 and the lower-trolley hoisting mechanism part-B c26 are respectively arranged on left and right sides of the upper-trolley hoisting mechanism c10. Since the machine room 16 is limited in space, the lower-trolley travelling mechanism c7 and the lower-trolley hoisting mechanism c8 which are newly added may also be mounted on the premise that the upper-trolley travelling mechanism c9 and the upper-trolley hoisting mechanism c10 are mounted, it is unnecessary to newly build a machine room and reduce the upgrading cost, and the remaining space of the original machine room 16 is sufficiently utilized. The present disclosure designs the novel lower-trolley hoisting mechanism c8 which specifically includes the lower-trolley hoisting mechanism part-A c25, the lower-trolley hoisting mechanism part-B c26 and the floating coupling c27, wherein due to the arrangement of the floating coupling c27, it can be ensured that the lower-trolley hoisting mechanism part-A c25 and the lower-trolley hoisting mechanism part-B c26 operate synchronously, and the problem that the hoist 4 of the lower trolley 3 tilts due to operation asynchronism of the two mechanisms is avoided, which is a great innovation for the lower-trolley hoisting mechanism c8. In addition, the machine room 16 is limited in space, in order to place the newly added lower-trolley hoisting mechanism part-A c25 and lower-trolley hoisting mechanism part-B c26 without newly building a machine room or reducing the upgrading cost, the floating coupling c27 plays a good linking role, and the floating coupling c27 is set to be small-sized and is respectively connected with the lower-trolley hoisting mechanism part-A c25 and the lower-trolley hoisting mechanism part-B c26 on the left and the right, so that the remaining space of the original machine room 16 is sufficiently utilized, the utility rate of the space is increased, and the stable operation of the newly added lower trolley can also be guaranteed. Specifically, the lower-trolley travelling mechanism part-A c28 includes a travelling drum-A, a motor, and a speed reducer, wherein one side of the speed reducer is connected with the motor by a shaft, and the other side of the speed reducer is connected with the travelling drum-A by a shaft. The lower-trolley travelling mechanism part-B c29 includes a travelling drum-B, a motor, and a speed reducer, wherein one side of the speed reducer is connected with the motor by a shaft, and the other side of the speed reducer is connected with the travelling drum-B by a shaft.

Further, the lower-trolley hoisting mechanism part-A c25 includes a hoist drum-A f23, a motor f28, and a speed reducer f29, wherein one side of the motor f28 is coaxially connected with the speed reducer f29, and the other side of the motor f28 is connected with the hoist drum-A f23 by a shaft; and the lower-trolley hoisting mechanism part-B c26 includes a hoist drum-B f18, a motor f28, and a speed reducer f29, wherein one side of the motor f28 is coaxially connected with the speed reducer f29, and the other side of the motor f28 is connected with the hoist drum-B f18 by a shaft.

Further, the lower-trolley hoisting winding system f6 includes a lower-trolley hoisting winding group-A f26 and a lower-trolley hoisting winding group-B f27, the lower-trolley hoisting mechanism part-A c25 is configured to drive the hoist 4 of the lower trolley 3 to rise and fall via the lower-trolley hoisting winding group-A f26, and meanwhile, the lower-trolley hoisting mechanism part-B c26 is configured to drive the hoist 4 of the lower trolley 3 to rise and fall via the lower-trolley hoisting winding group-B f27.

Further, the recessed frame d5 includes a horizontal frame d4, a first vertical frame group d8, and a second vertical frame group d9, wherein one end of the horizontal frame d4 is connected with an end of the first vertical frame group d8, the other end of the horizontal frame d4 is connected with an end of the second vertical frame group d9, and structures of the first vertical frame group d8 and the second vertical frame group d9 are symmetrically disposed relative to the middle of the horizontal frame d4; wherein a first horizontal support frame-A f34 is further connected to the top of the first vertical frame group d8, and a first horizontal support frame-B f35 is further connected to the top of the second vertical frame group d9. The lower-trolley hoisting winding group-A f26 includes a first quay crane redirecting pulley f30 and a second quay crane redirecting pulley f31 which are mounted on the quay crane, further includes a thirteenth pulley 113, a fourteenth pulley 114, a fifteenth pulley 115, a twenty-second pulley 122, a twenty-third pulley 123, and a twenty-fourth pulley 124 which are mounted on the first horizontal support frame-A f34, further includes a sixteenth pulley 116 and a twenty-first pulley 121 which are mounted on the first vertical frame group d8, further includes a seventeenth pulley 117, an eighteenth pulley 118, a nineteenth pulley 119, and a twentieth pulley 120 which are mounted on the horizontal frame d4, further includes a hoist pulley-A f19 mounted on the hoist 4 of the lower trolley 3, and further includes a quay crane pulley-A f21 mounted on the double-trapezoid four-track girder 1 of the quay crane. The lower-trolley hoisting winding group-B f27 includes a hoist rope-A f17, further includes a third quay crane redirecting pulley f32 and a fourth quay crane redirecting pulley f33 which are mounted on the quay crane, further includes a first pulley 101, a second pulley 102, a third pulley 103, a tenth pulley 110, an eleventh pulley 111, and a twelfth pulley 112 which are mounted on the first horizontal support frame-B f35, further includes a fourth pulley 104 and a ninth pulley 109 which are mounted on the second vertical frame group d9, further includes a fifth pulley 105, a sixth pulley 106, a seventh pulley 107, and an eighth pulley 108 which are mounted on the horizontal frame d4, further includes a hoist pulley-B f20 mounted on the hoist 4 of the lower trolley 3, and further includes a quay crane pulley-B f22 mounted on the double-trapezoid four-track girder 1 of the quay crane. Specifically, one end of the hoist rope-A f17 is wound on the hoist drum-B f18, and the other end of the hoist rope-A f17, after being sequentially wound through an upper side of the third quay crane redirecting pulley f32, wound through a lower side of the fourth quay crane redirecting pulley f33, wound through a lower side of the first pulley 101, redirected by 180 degrees, wound through the second pulley 102, redirected by 180 degrees, wound through the third pulley 103, downwards wound through the fourth pulley 104, further downwards wound through the fifth pulley 105, horizontally redirected, wound through the sixth pulley 106, vertically redirected, wound through the hoist pulley-B f20, vertically and upwards redirected by 180 degrees, wound through the seventh pulley 107, wound through a lower side of the eighth pulley 108, vertically and upwards wound through the ninth pulley 109, upwards wound through the tenth pulley 110, wound through the eleventh pulley 111, horizontally redirected by 180 degrees, further wound through the twelfth pulley 112, horizontally redirected by 180 degrees, wound through the quay crane pulley-B f22, wound through the quay crane pulley-A f21, wound through the thirteenth pulley 113, redirected by 180 degrees, wound through the fourteenth pulley 114, redirected by 180 degrees, wound through the fifteenth pulley 115, downwards wound through the sixteenth pulley 116, further downwards wound through the seventeenth pulley 117, horizontally redirected, wound through the eighteenth pulley 118, vertically redirected, wound through the hoist pulley-A f19, redirected by 180 degrees, wound through the nineteenth pulley 119, wound through the twentieth pulley 120, wound through the twenty-first pulley 121, wound through the twenty-second pulley 122, wound through the twenty-third pulley 123, redirected by 180 degrees, wound through the twenty-fourth pulley 124, redirected by 180 degrees, wound through the second quay crane redirecting pulley f31, and wound through the first quay crane redirecting pulley f30, is finally wound on the hoist drum-A f23.

Further, two rope dragging frames f24 are further arranged on outer side surfaces of the double-trapezoid four-track girder 1 in the longitudinal direction of the girder, and the hoist rope-A f17 is arranged on the rope dragging frames f24.

Embodiment 3: as shown in FIG. 1 to FIG. 12, provided is an upgraded quay crane system, wherein a conventional quay crane girder is upgraded into a double-trapezoid four-track girder 1. Upper-trolley running tracks a16 on inner sides of the double-trapezoid four-track girder 1 are configured for an upper trolley 2 to travel on, a lower trolley 3 is suspended upside down on lower-trolley running tracks a8 on outer sides of the double-trapezoid four-track girder 1, and a container 5 hoisted by the upper trolley 2 via a hoist 4 is able to pass through the lower trolley 3. The double-trapezoid four-track girder 1 includes original box beams a4, plates-A a5, plates-B a6, and track bearing beams a7; tops of the two original box beams a4 are interconnected by a connecting frame a11 of a quay crane, structures of the two original box beams a4 are symmetrically disposed relative to the center of the connecting frame a11, sections of bottom parts of the two original box beams a4 are of right-angled trapezoids, each of the right-angled trapezoids includes a right-angled side a12, an oblique side a13, an upper base a14, and a lower base a15, the oblique sides a13 of the bottom parts of the two original box beams a4 are both located on inner sides of the quay crane, the right-angled sides a12 thereof are both located on outer sides of the quay crane, and the two oblique sides a13 are provided with the upper-trolley running tracks a16 which are symmetrically arranged; each of the plates-B a6 is laid along the longitudinal direction of a corresponding original box beam a4, each of the plates-B a6 is located on an outer side of a corresponding lower base a15, one side of each of the plates-B a6 is connected with one side of the corresponding lower base a15, and each of the plates-B a6 is located on the same horizontal height as the corresponding lower base a15; each of the plates-A a5 is laid along the longitudinal direction of a corresponding original box beam a4, one side of each of the plates-A a5 is connected with the other side, away from a corresponding lower base a15, of a corresponding plate-B a6, and the other side of each of the plates-A a5 is connected with an outer side of the corresponding original box beam a4; and each of the track bearing beams a7 is mounted on one end, away from a corresponding lower base a15, of a corresponding plate-B a6, and each of the lower-trolley running tracks a8 is laid on a corresponding track bearing beam a7. According to the present disclosure, the conventional quay crane girder is upgraded, outer sides of the two original box beams a4 are each provided with two plates to form a girder with a double-trapezoid section, and the outer side of the girder with the double-trapezoid section is additionally provided with track bearing beams a7 and is laid with the lower-trolley running tracks a8 to bear the newly added lower trolley 3 which is suspended upside down. The track pitch between the original upper-trolley running tracks a16 of the original box beams a4 is kept unchanged, and the two upper-trolley running tracks a16 which are symmetrically arranged are configured for the upper trolley to travel on. The lower trolley 3 is additionally arranged on the outer-side tracks of the original box beams a4. The two trolleys are vertically disposed, and the space structure for the lower trolley is cleverly designed, such that the upper trolley 2 and the lower trolley 3 of the upgraded quay crane have enough space to pass by each other without interfering with each other; and the quay crane is upgraded from one trolley to two trolleys to operate, so that the operation efficiency of the quay crane is greatly increased. According to the present disclosure, the loading and unloading efficiency of an original quay crane can be greatly increased with relatively low upgrading investment without newly building and replacing with a quay crane, and the two trolleys of the upgraded quay crane have enough space to pass by each other and operate at the same time, thereby doubling the loading and unloading efficiency.

Further, the lower trolley 3 includes a recessed frame d5, a movable trolley d6 and wheels d13, wherein the wheels d13 are arranged on two sides of the top of the recessed frame d5 and are configured to roll on the lower-trolley running tracks a8 on the outer sides of the double-trapezoid four-track girder 1, the movable trolley d6 is arranged on the bottom of the recessed frame d5, and the hoist 4 is connected below the movable trolley d6. The lower trolley is provided with the recessed frame d5 which forms a recessed self-closed space in space, and such a space is large enough to allow the container 5 hoisted by the upper trolley 2 to pass by without interference. Compared with a U-shaped frame of a lower trolley of a novel quay crane, the present structure allows the upper trolley 2 to pass through the recessed space of the lower trolley 3 without changing the position of the double-trapezoid four-track girder 1, thereby reducing the investment. The movable trolley d6 is used for bearing the hoist 4 and is capable of moving on the recessed frame d5.

Further, a movable trolley track is laid on the bottom of the recessed frame d5, the movable trolley d6 includes a trolley body d10 and travelling wheels d17, and the travelling wheels d17 are mounted on two sides of the bottom of the trolley body d10 and are configured to roll on the movable trolley track.

Further, the recessed frame d5 includes a horizontal frame d4, a first vertical frame group d8, and a second vertical frame group d9, wherein one end of the horizontal frame d4 is connected with an end of the first vertical frame group d8, the other end of the horizontal frame d4 is connected with an end of the second vertical frame group d9, and structures of the first vertical frame group d8 and the second vertical frame group d9 are symmetrically disposed relative to the middle of the horizontal frame d4. The first vertical frame group d8 includes a first vertical rod d19 and a second vertical rod d20; the second vertical frame group d9 further includes a first vertical rod d19 and a second vertical rod d20; and the wheels d13 are arranged on top ends of the first vertical rods d19, the other ends of the first vertical rods d19 are connected with ends of the second vertical rods d20, and the other ends, away from the first vertical rods d19, of the second vertical rods d20 are connected with the horizontal frame d4. In such a layout way, the upper trolley 2 and the lower trolley 3 can pass by each other without changing a girder spacing of the conventional quay crane on the premise that the upgrading cost is relatively low, and interference can also be avoided.

Further, horizontal guide wheel groups d7 are further mounted on the top of the recessed frame d5 and are arranged on outer sides of the wheels d13; each of the horizontal guide wheel groups d7 includes a horizontal wheel d18 and a rotation shaft d21, and the horizontal wheel d18 is coaxially sleeved on the rotation shaft d21 and is able to rotate around the rotation shaft d21; and the horizontal wheel d18 has a shape of an inverted horn. The horizontal guide wheel group d7 can prevent the wheels d13 of the lower trolley 3 from deviating and also reduce the abrasion of the lower-trolley running tracks a8. Specifically, when the lower trolley 3 laterally deviates, the horizontal guide wheel group d7 may abut against the outer sides of the wheels d13 to correct the lateral deviation of the wheels d13 by virtue of an opposite force. In addition, when the lower trolley 3 deviates from the lower-trolley running tracks a8, the horizontal wheel d18 rotates on sides of the lower-trolley running tracks a8 around the rotation shaft d21, so that friction can be reduced, and the abrasion of the lower-trolley running tracks a8 can be reduced.

Further, trolley moving devices e7 are further mounted on two sides of the movable trolley d6, each of the trolley moving devices e7 includes a motor e18, a speed reducer e21, an electrically-driven push rod e22, and a supporting seat e23, wherein the motor e18 is connected with the speed reducer e21 by a shaft, the speed reducer e21 is connected with the electrically-driven push rod e22 by a shaft, one end, away from the speed reducer e21, of the electrically-driven push rod e22 is connected with the trolley body d10 of the movable trolley d6, and the bottom of the electrically-driven push rod e22 is fixedly arranged on the horizontal frame d4 via the supporting seat e23. The trolley moving devices e7 have various functions including a first function of controlling the movable trolley d6 to accurately move and a second function of fixing the movable trolley d6. Specifically, the motor e18 supplies power for realizing the extension and contraction of the electrically-driven push rod e22, the electrically-driven push rod e22 is connected with the trolley body d10 to control the moving position of the movable trolley d6, in addition, the speed reducer e21 may be used for speed adjustment. The trolley moving devices e7 control the movable trolley d6 to move the hoist 4, thereby completing box operation; and the fine adjustment process is rapid, simple and convenient, and the loading and unloading efficiency is increased. The trolley moving devices e7 limit the displacement of the movable trolley d6 on the movable trolley track, and the movable trolley d6 is fixed when the electrically-driven push rod e22 is locked, so that potential safety hazards caused by waggle of the movable trolley d6 under the action of an external force such as crosswind are avoided.

Further, the lower-trolley hoisting winding system f6 includes a lower-trolley hoisting winding group-A f26 and a lower-trolley hoisting winding group-B f27, the lower-trolley hoisting mechanism part-A c25 is configured to drive the hoist 4 of the lower trolley 3 to rise and fall via the lower-trolley hoisting winding group-A f26, and meanwhile, the lower-trolley hoisting mechanism part-B c26 is configured to drive the hoist 4 of the lower trolley 3 to rise and fall via the lower-trolley hoisting winding group-B f27.

Further, the recessed frame d5 includes a horizontal frame d4, a first vertical frame group d8, and a second vertical frame group d9, wherein one end of the horizontal frame d4 is connected with an end of the first vertical frame group d8, the other end of the horizontal frame d4 is connected with an end of the second vertical frame group d9, and structures of the first vertical frame group d8 and the second vertical frame group d9 are symmetrically disposed relative to the middle of the horizontal frame d4; wherein a first horizontal support frame-A f34 is further connected to the top of the first vertical frame group d8, and a first horizontal support frame-B f35 is further connected to the top of the second vertical frame group d9. The lower-trolley hoisting winding group-A f26 includes a first quay crane redirecting pulley f30 and a second quay crane redirecting pulley f31 which are mounted on the quay crane, further includes a thirteenth pulley 113, a fourteenth pulley 114, a fifteenth pulley 115, a twenty-second pulley 122, a twenty-third pulley 123, and a twenty-fourth pulley 124 which are mounted on the first horizontal support frame-A f34, further includes a sixteenth pulley 116 and a twenty-first pulley 121 which are mounted on the first vertical frame group d8, further includes a seventeenth pulley 117, an eighteenth pulley 118, a nineteenth pulley 119, and a twentieth pulley 120 which are mounted on the horizontal frame d4, further includes a hoist pulley-A f19 mounted on the hoist 4 of the lower trolley 3, and further includes a quay crane pulley-A f21 mounted on the double-trapezoid four-track girder 1 of the quay crane. The lower-trolley hoisting winding group-B f27 includes a hoist rope-A f17, further includes a third quay crane redirecting pulley f32 and a fourth quay crane redirecting pulley f33 which are mounted on the quay crane, further includes a first pulley 101, a second pulley 102, a third pulley 103, a tenth pulley 110, an eleventh pulley 111, and a twelfth pulley 112 which are mounted on the first horizontal support frame-B f35, further includes a fourth pulley 104 and a ninth pulley 109 which are mounted on the second vertical frame group d9, further includes a fifth pulley 105, a sixth pulley 106, a seventh pulley 107, and an eighth pulley 108 which are mounted on the horizontal frame d4, further includes a hoist pulley-B f20 mounted on the hoist 4 of the lower trolley 3, and further includes a quay crane pulley-B f22 mounted on the double-trapezoid four-track girder 1 of the quay crane. Specifically, one end of the hoist rope-A f17 is wound on the hoist drum-B f18, and the other end of the hoist rope-A f17, after being sequentially wound through an upper side of the third quay crane redirecting pulley f32, wound through a lower side of the fourth quay crane redirecting pulley f33, wound through a lower side of the first pulley 101, redirected by 180 degrees, wound through the second pulley 102, redirected by 180 degrees, wound through the third pulley 103, downwards wound through the fourth pulley 104, further downwards wound through the fifth pulley 105, horizontally redirected, wound through the sixth pulley 106, vertically redirected, wound through the hoist pulley-B f20, vertically and upwards redirected by 180 degrees, wound through the seventh pulley 107, wound through a lower side of the eighth pulley 108, vertically and upwards wound through the ninth pulley 109, upwards wound through the tenth pulley 110, wound through the eleventh pulley 111, horizontally redirected by 180 degrees, further wound through the twelfth pulley 112, horizontally redirected by 180 degrees, wound through the quay crane pulley-B f22, wound through the quay crane pulley-A f21, wound through the thirteenth pulley 113, redirected by 180 degrees, wound through the fourteenth pulley 114, redirected by 180 degrees, wound through the fifteenth pulley 115, downwards wound through the sixteenth pulley 116, further downwards wound through the seventeenth pulley 117, horizontally redirected, wound through the eighteenth pulley 118, vertically redirected, wound through the hoist pulley-A f19, redirected by 180 degrees, wound through the nineteenth pulley 119, wound through the twentieth pulley 120, wound through the twenty-first pulley 121, wound through the twenty-second pulley 122, wound through the twenty-third pulley 123, redirected by 180 degrees, wound through the twenty-fourth pulley 124, redirected by 180 degrees, wound through the second quay crane redirecting pulley f31, and wound through the first quay crane redirecting pulley f30, is finally wound on the hoist drum-A f23.

Further, four rope dragging frames f24 are further arranged on outer side surfaces of the double-trapezoid four-track girder 1 in the longitudinal direction of the girder, and the hoist rope-A f17 is arranged on the rope dragging frames f24.

Embodiment 4: as shown in FIG. 1 to FIG. 12, provided is an operation process of the aforementioned upgraded quay crane system, wherein the operation process includes the following steps: upgrading a conventional quay crane girder into a double-trapezoid four-track girder 1, arranging an upper trolley to travel on upper-trolley running tracks a16 on inner sides of the double-trapezoid four-track girder 1, suspending a lower trolley 3 upside down on lower-trolley running tracks a8 on outer sides of the double-trapezoid four-track girder 1, wherein a container 5 hoisted by the upper trolley 2 via a hoist 4 is able to pass through the lower trolley 3, wherein an upper-trolley travelling mechanism c9 drives the upper trolley 2 to travel along the upper-trolley running tracks a16 via an upper-trolley travelling winding system, and an upper-trolley hoisting mechanism c10 drives the upper trolley 2 to rise and fall via an upper-trolley hoisting winding system; a lower-trolley travelling mechanism c7 drives the lower trolley 3 to travel along the lower-trolley running tracks a8 via a lower-trolley travelling winding system; a lower-trolley hoisting mechanism c8 drives the hoist 4 of the lower trolley 3 to rise and fall via a lower-trolley hoisting winding system f6; wherein the lower-trolley travelling mechanism c7, the lower-trolley hoisting mechanism c8, the upper-trolley travelling mechanism c9 and the upper-trolley hoisting mechanism c10 are all arranged in a same machine room 16 of a quay crane, and the upper-trolley hoisting winding system, the lower-trolley hoisting winding system f6, the upper-trolley travelling winding system and the lower-trolley travelling winding system are effectively staggered on the quay crane without interfering with each other.

The working principle of the upgraded quay crane system is that the present disclosure provides a solution for upgrading the conventional quay crane having the single trolley, which can be used for upgrading the conventional quay crane having the single trolley to increase the loading and unloading efficiency of the present quay crane. Specifically, a conventional quay crane girder is upgraded into a double-trapezoid four-track girder 1, a lower trolley 3 which is recessed is suspended upside down on lower-trolley running tracks a8 on outer sides of the girder, steel ropes of a lower-trolley travelling winding system are wound on the lower trolley 3 to pull the lower trolley 3 to move along the lower-trolley running tracks a8 on the outer sides of the double-trapezoid four-track girder 1, steel ropes of a lower-trolley hoisting winding system are wound on the lower trolley 3 and a hoist 4 to take charge of the rise and fall of the hoist 4 of the lower trolley 3. The original upper trolley 2 travels on upper-trolley running tracks a16 on inner sides of the girder, steel ropes of an upper-trolley travelling winding system are wound on the upper trolley 2 to pull the upper trolley 2 to move along the upper-trolley running tracks a16 of the double-trapezoid four-track girder 1, and steel ropes of an upper-trolley hoisting winding system are wound on the upper trolley 2 and a hoist 4 to take charge of the rise and fall of the hoist 4 of the upper trolley. The position of a machine room 16 of a quay crane is kept unchanged, and an electric room is added in the middle of a portal leg of the quay crane. In the machine room 16, the steel ropes of the upper-trolley travelling winding system are wound on an upper-trolley travelling mechanism c9, the steel ropes of the upper-trolley hoisting winding system are wound on an upper-trolley hoisting mechanism c10, the steel ropes of the lower-trolley travelling winding system are wound on a lower-trolley travelling mechanism c7, and the steel ropes of the lower-trolley hoisting winding system f6 are wound on a lower-trolley hoisting mechanism c8.

The lower-trolley travelling mechanism c7 and the lower-trolley hoisting mechanism c8 are arranged on two sides of the upper-trolley travelling mechanism c9 and the upper-trolley hoisting mechanism c10. The lower trolley 3 is of a structure having a recessed space, a container 5 hoisted by the upper trolley 2 via the hoist 4 can pass through the recessed space of the lower trolley 3 without interference. The two trolleys of the upgraded quay crane have enough space to pass by each other and operate at the same time, thereby doubling the loading and unloading efficiency.

What is claimed is:

1. An upgraded quay crane system, wherein a conventional quay crane girder is upgraded into a double-trapezoid four-track girder (1), upper-trolley running tracks (a16) on inner sides of the double-trapezoid four-track girder (1) are configured for an upper trolley (2) to travel on, a lower trolley (3) is suspended upside down on lower-trolley running tracks (a8) on outer sides of the double-trapezoid four-track girder (1), and a container (5) hoisted by the upper trolley (2) via a hoist (4) is able to pass through the lower trolley (3);
wherein the double-trapezoid four-track girder (1) comprises original box beams (a4), plates-A (a5), plates-B (a6), and track bearing beams (a7); tops of the two original box beams (a4) are interconnected by a connecting frame (a11) of a quay crane, structures of the two original box beams (a4) are symmetrically disposed relative to the center of the connecting frame (a11), sections of bottom parts of the two original box beams (a4) are of right-angled trapezoids, each of the right-angled trapezoids comprises a right-angled side (a12), an oblique side (a13), an upper base (a14), and a lower base (a15), the oblique sides (a13) of the bottom parts of the two original box beams (a4) are both located on inner sides of the quay crane, the right-angled sides (a12) thereof are both located on outer sides of the quay crane, and the two oblique sides (a13) are provided with the upper-trolley running tracks (a16) which are symmetrically arranged; each of the plates-B (a6) is laid along the longitudinal direction of a corresponding original box beam (a4), each of the plates-B (a6) is located on an outer side of a corresponding lower base (a15), one side of each of the plates-B (a6) is connected with one side of the corresponding lower base (a15), and each of the plates-B (a6) is located on the same horizontal height as the corresponding lower base (a15); each of the plates-A (a5) is laid along the longitudinal direction of a corresponding original box beam (a4), one side of each of the plates-A (a5) is connected with the other side, away from a corresponding lower base (a15), of a corresponding plate-B (a6), and the other side of each of the plates-A (a5) is connected with an outer side of the corresponding original box beam (a4); and each of the track bearing beams (a7) is mounted on one end, away from a corresponding lower base (a15), of a corresponding plate-B (a6), and each of the lower-trolley running tracks (a8) is laid on a corresponding track bearing beam (a7).

2. The upgraded quay crane system of claim 1, wherein the upper trolley (2) comprises an upper trolley body (b9), the hoist (4) comprises an upper hoist frame (b5), and the upper trolley body (b9) is connected to the upper hoist frame (b5) via steel ropes; a guide device (b4) comprising a guide frame (b7) and a guide rod (b8) is further arranged between the upper trolley body (b9) and the upper hoist frame (b5), the guide frame (b7) is arranged on the top of the upper hoist frame (b5), the guide rod (b8) is arranged on the bottom of the upper trolley body (b9), and the guide frame (b7) is configured to slidably engage the guide rod (b8); and the guide frame (b7) comprises a guide groove (b10) and a supporting structure (b11), and the guide groove (b10) is arranged on the top of the supporting structure (b11).

3. The upgraded quay crane system of claim 1, further comprising a lower-trolley travelling mechanism (c7), a lower-trolley hoisting mechanism (c8), an upper-trolley travelling mechanism (c9), an upper-trolley hoisting mechanism (c10), an upper-trolley hoisting winding system, a lower-trolley hoisting winding system (f6), an upper-trolley travelling winding system, and a lower-trolley travelling winding system, wherein the upper-trolley travelling mechanism (c9) is configured to drive the upper trolley (2) to travel along the upper-trolley running tracks (a16) via the upper-trolley travelling winding system, and the upper-trolley hoisting mechanism (c10) is configured to drive the upper trolley (2) to rise and fall via the upper-trolley hoisting winding system; the lower-trolley travelling mechanism (c7) is configured to drive the lower trolley (3) to travel along the lower-trolley running tracks (a8) via the lower-trolley travelling winding system; the lower-trolley hoisting mechanism (c8) is configured to drive the hoist (4) of the lower trolley (3) to rise and fall via the lower-trolley hoisting winding system (f6); wherein the lower-trolley travelling mechanism (c7), the lower-trolley hoisting mechanism (c8), the upper-trolley travelling mechanism (c9) and the upper-trolley hoisting mechanism (c10) are all arranged in a same machine room (16) of the quay crane, and the upper-trolley hoisting winding system, the lower-trolley hoisting winding system (f6), the upper-trolley travelling winding system and the lower-trolley travelling winding system are effectively staggered on the quay crane without interfering with each other.

4. The upgraded quay crane system of claim 3, wherein the upper-trolley hoisting mechanism (c10) is arranged in front of the upper-trolley travelling mechanism (c9); the lower-trolley travelling mechanism (c7) comprises a lower-trolley travelling mechanism part-A (c28) and a lower-trolley travelling mechanism part-B (c29) which are respectively arranged on left and right sides of the upper-trolley travelling mechanism (c9); the lower-trolley hoisting mechanism (c8) comprises a lower-trolley hoisting mechanism part-A (c25), a lower-trolley hoisting mechanism part-B (c26), and a floating coupling (c27), the lower-trolley hoisting mechanism part-A (c25) is connected to the lower-trolley hoisting mechanism part-B (c26) via the floating coupling (c27), wherein the floating coupling (c27) is horizontally arranged in a gap between the upper-trolley travelling mechanism (c9) and the upper-trolley hoisting mechanism (c10), and the lower-trolley hoisting mechanism part-A (c25) and the lower-trolley hoisting mechanism part-B (c26) are respectively arranged on left and right sides of the upper-trolley hoisting mechanism (c10).

5. The upgraded quay crane system of claim 1, wherein the lower trolley (3) comprises a recessed frame (d5), a movable trolley (d6) and wheels (d13), wherein the wheels (d13) are arranged on two sides of the top of the recessed frame (d5) and are configured to roll on the lower-trolley running tracks (a8) on the outer sides of the double-trapezoid four-track girder (1), the movable trolley (d6) is arranged on the bottom of the recessed frame (d5), and the hoist (4) is connected below the movable trolley (d6).

6. The upgraded quay crane system of claim 5, wherein a movable trolley track is laid on the bottom of the recessed frame (d5), the movable trolley (d6) comprises a trolley body (d10) and travelling wheels (d17), and the travelling wheels (d17) are mounted on two sides of the bottom of the trolley body (d10) and are configured to roll on the movable trolley track.

7. The upgraded quay crane system of claim 6, wherein the recessed frame (d5) comprises a horizontal frame (d4), a first vertical frame group (d8), and a second vertical frame group (d9), wherein one end of the horizontal frame (d4) is connected with an end of the first vertical frame group (d8), the other end of the horizontal frame (d4) is connected with an end of the second vertical frame group (d9), and structures of the first vertical frame group (d8) and the second vertical frame group (d9) are symmetrically disposed relative to the middle of the horizontal frame (d4); and
the first vertical frame group (d8) comprises a first vertical rod (d19) and a second vertical rod (d20); the second vertical frame group (d9) further comprises a first vertical rod (d19) and a second vertical rod (d20); and the wheels (d13) are arranged on top ends of the first vertical rods (d19), the other ends of the first vertical rods (d19) are connected with ends of the second vertical rods (d20), and the other ends, away from the first vertical rods (d19), of the second vertical rods (d20) are connected with the horizontal frame (d4).

8. The upgraded quay crane system of claim 7, wherein horizontal guide wheel groups (d7) are further mounted on the top of the recessed frame (d5) and are arranged on outer sides of the wheels (d13); each of the horizontal guide wheel groups (d7) comprises a horizontal wheel (d18) and a rotation shaft (d21), and the horizontal wheel (d18) is coaxially sleeved on the rotation shaft (d21) and is able to rotate around the rotation shaft (d21); and the horizontal wheel (d18) has a shape of an inverted horn.

9. The upgraded quay crane system of claim 7, wherein trolley moving devices (e7) are further mounted on two sides of the movable trolley (d6), each of the trolley moving devices (e7) comprises a motor (e18), a speed reducer (e21), an electrically-driven push rod (e22), and a supporting seat (e23), wherein the motor (e18) is connected with the speed reducer (e21) by a shaft, the speed reducer (e21) is connected with the electrically-driven push rod (e22) by a shaft, one end, away from the speed reducer (e21), of the electrically-driven push rod (e22) is connected with the trolley body (d10) of the movable trolley (d6), and the bottom of the electrically-driven push rod (e22) is fixedly arranged on the horizontal frame (d4) via the supporting seat (e23).

10. The upgraded quay crane system of claim 4, wherein the lower-trolley hoisting mechanism part-A (c25) comprises a hoist drum-A (f23), a motor (f28), and a speed reducer (f29), wherein one side of the motor (f28) is coaxially connected with the speed reducer (f29), and the other side of the motor (f28) is connected with the hoist drum-A (f23) by a shaft; and the lower-trolley hoisting mechanism part-B (c26) comprises a hoist drum-B (f18), a motor (f28), and a speed reducer (f29), wherein one side of the motor (f28) is coaxially connected with the speed reducer (f29), and the other side of the motor (f28) is connected with the hoist drum-B (f18) by a shaft.

11. The upgraded quay crane system of claim 9, wherein the lower-trolley hoisting winding system (f6) comprises a lower-trolley hoisting winding group-A (f26) and a lower-trolley hoisting winding group-B (f27), the lower-trolley hoisting mechanism part-A (c25) is configured to drive the hoist (4) of the lower trolley (3) to rise and fall via the lower-trolley hoisting winding group-A (f26), and meanwhile, the lower-trolley hoisting mechanism part-B (c26) is configured to drive the hoist (4) of the lower trolley (3) to rise and fall via the lower-trolley hoisting winding group-B (f27).

12. The upgraded quay crane system of claim 11, wherein the recessed frame (d5) comprises a horizontal frame (d4), a first vertical frame group (d8), and a second vertical frame group (d9), wherein one end of the horizontal frame (d4) is connected with an end of the first vertical frame group (d8), the other end of the horizontal frame (d4) is connected with an end of the second vertical frame group (d9), and structures of the first vertical frame group (d8) and the second vertical frame group (d9) are symmetrically disposed relative to the middle of the horizontal frame (d4); wherein a first horizontal support frame-A (f34) is further connected to the top of the first vertical frame group (d8), and a first horizontal support frame-B (f35) is further connected to the top of the second vertical frame group (d9);
the lower-trolley hoisting winding group-A (f26) comprises a first quay crane redirecting pulley (f30) and a second quay crane redirecting pulley (f31) which are mounted on the quay crane, further comprises a thirteenth pulley (113), a fourteenth pulley (114), a fifteenth pulley (115), a twenty-second pulley (122), a twenty-third pulley (123), and a twenty-fourth pulley (124) which are mounted on the first horizontal support frame-A (f34), further comprises a sixteenth pulley (116) and a twenty-first pulley (121) which are mounted on the first vertical frame group (d8), further comprises a seventeenth pulley (117), an eighteenth pulley (118), a nineteenth pulley (119), and a twentieth pulley (120) which are mounted on the horizontal frame (d4), further comprises a hoist pulley-A (f19) mounted on the hoist (4) of the lower trolley (3), and further comprises a quay crane pulley-A (f21) mounted on the double-trapezoid four-track girder (1) of the quay crane;
the lower-trolley hoisting winding group-B (f27) comprises a hoist rope-A (f17), further comprises a third quay crane redirecting pulley (f32) and a fourth quay crane redirecting pulley (f33) which are mounted on the quay crane, further comprises a first pulley (101), a second pulley (102), a third pulley (103), a tenth pulley (110), an eleventh pulley (111), and a twelfth pulley (112) which are mounted on the first horizontal support frame-B (f35), further comprises a fourth pulley (104) and a ninth pulley (109) which are mounted on the second vertical frame group (d9), further comprises a fifth pulley (105), a sixth pulley (106), a seventh pulley (107), and an eighth pulley (108) which are mounted on the horizontal frame (d4), further comprises a hoist pulley-B (f20) mounted on the hoist (4) of the lower trolley (3), and further comprises a quay crane pulley-B (f22) mounted on the double-trapezoid four-track girder (1) of the quay crane; and
one end of the hoist rope-A (f17) is wound on the hoist drum-B (f18), and the other end of the hoist rope-A (f17), after being sequentially wound through an upper side of the third quay crane redirecting pulley (f32), wound through a lower side of the fourth quay crane redirecting pulley (f33), wound through a lower side of the first pulley (101), redirected by 180 degrees, wound through the second pulley (102), redirected by 180 degrees, wound through the third pulley (103), downwards wound through the fourth pulley (104), further downwards wound through the fifth pulley (105), horizontally redirected, wound through the sixth pulley (106), vertically redirected, wound through the hoist pulley-B (f20), vertically and upwards redirected by 180 degrees, wound through the seventh pulley (107), wound through a lower side of the eighth pulley (108), vertically and upwards wound through the ninth pulley (109), upwards wound through the tenth pulley (110), wound through the eleventh pulley (111), horizontally redirected by 180 degrees, further wound through the twelfth pulley (112), horizontally redirected by 180 degrees, wound through the quay crane pulley-B (f22), wound through the quay crane pulley-A (f21), wound through the thirteenth pulley (113), redirected by 180 degrees, wound through the fourteenth pulley (114), redirected by 180 degrees, wound through the fifteenth pulley (115), downwards wound through the sixteenth pulley (116), further downwards wound through the seventeenth pulley (117), horizontally redirected, wound through the eighteenth pulley (118), vertically redirected, wound through the hoist pulley-A (f19), redirected by 180 degrees, wound through the nineteenth pulley (119), wound through the twentieth pulley (120), wound through the twenty-first pulley (121), wound through the twenty-second pulley (122), wound through the twenty-third pulley (123), redirected by 180 degrees, wound through the twenty-fourth pulley (124), redirected by 180 degrees, wound through the second quay crane redirecting pulley (f31), and wound through the first quay crane redirecting pulley (f30), is finally wound on the hoist drum-A (f23).

13. The upgraded quay crane system of claim 12, wherein a plurality of rope dragging frames (f24) are further arranged on outer side surfaces of the double-trapezoid four-track girder (1) in the longitudinal direction of the girder, and the hoist rope-A (f17) is arranged on the rope dragging frames (f24).

14. The upgraded quay crane system of claim 2, wherein the upper trolley body (b9) is connected with both sides of the upper hoist frame (b5) by the steel ropes, and the guide device (b4) is arranged on inner sides of the steel ropes.

15. An operation process of the upgraded quay crane system of claim 1, wherein the operation process comprises the following steps: upgrading a conventional quay crane girder into a double-trapezoid four-track girder (1), arranging an upper trolley (2) to travel on upper-trolley running tracks (a16) on inner sides of the double-trapezoid four-track girder (1), suspending a lower trolley (3) upside down on lower-trolley running tracks (a8) on outer sides of the double-trapezoid four-track girder (1), wherein a container (5) hoisted by the upper trolley (2) via a hoist (4) is able to pass through the lower trolley (3);
wherein an upper-trolley travelling mechanism (c9) drives the upper trolley (2) to travel along the upper-trolley running tracks (a16) via an upper-trolley travelling winding system, and an upper-trolley hoisting mechanism (c10) drives the upper trolley (2) to rise and fall via an upper-trolley hoisting winding system; a lower-trolley travelling mechanism (c7) drives the lower trolley (3) to travel along the lower-trolley running tracks (a8) via a lower-trolley travelling winding system; a lower-trolley hoisting mechanism (c8) drives the hoist (4) of the lower trolley (3) to rise and fall via a lower-trolley hoisting winding system (f6); wherein the lower-trolley travelling mechanism (c7), the lower-trolley hoisting mechanism (c8), the upper-trolley travelling mechanism (c9) and the upper-trolley hoisting mechanism (c10) are all arranged in a same machine room (16) of a quay crane, and the upper-trolley hoisting winding system, the lower-trolley hoisting winding system (f6), the upper-trolley travelling winding system and the lower-trolley travelling winding system are effectively staggered on the quay crane without interfering with each other.
